(19) United States
(12) Patent Application Publication
(10) Pub. No.: US 2007/0030771 A1
(43) Pub. Date: Feb. 8, 2007

(54) Method for automatically correcting an operation type of a disk drive

(75) Inventors: Wei-Ting Huang, Taoyuan (TW); Ping-Hsiu Chen, Taoyuan (TW); Yi-Long Hsiao, Taoyuan (TW)

Correspondence Address: BIRCH STEWART KOLASCH & BIRCH, PO BOX 747, FALLS CHURCH, VA, 22040-0747, US

(73) Assignee: QUANTA STORAGE INC.

(21) Appl. No.: 11/496,625

(22) Filed: Aug. 1, 2006

(30) Foreign Application Priority Data
Aug. 2, 2005 (TW) 94126301

(51) Int. Cl. G11B 7/00

(52) U.S. Cl. 369/44.25; 369/44.11

(57) ABSTRACT

A method for automatically correcting an operation type of a disk drive sets a number of times of normal track seeking of the disk drive as a standard. When executing track seeking commands, the method also detects whether a number of times of track seeking in the track seeking commands is greater than the standard, judges occurrence of an abnormal track seeking phenomenon, judges a correct operation type according to an operation type setting of the disk drive and a track seeking direction, automatically corrects and switches a misjudged operation type into the correct operation type setting, and restores to the original operation type setting after the operation type is controlled and switched for a predetermined number of times so as to timely and automatically revise the misjudged operation type setting.

This application claims the benefit of Taiwan application Serial No. 94126301, filed Aug. 2, 2005, the subject matter of which is incorporated herein by reference.

### BACKGROUND OF THE INVENTION

1. Field of the Invention

The invention relates in general to a method of correcting a disk drive, and more particularly to a method of judging an incorrect operation type of a disk drive and automatically switching an operation type in order to correct and control a driving force to drive a pickup to seek a track smoothly.

2. Description of the Related Art

Because data marks are densely recorded on tracks of volute or concentric circles of an optical disk, a pickup of an optical drive has to be moved precisely to read or write data. As shown in FIG. 1, the prior art disk drive has a spindle motor 2 for rotating an optical disk 3, and a longitudinal slot 4 formed along a radial direction of the optical disk 3. A pickup 5 is driven to move in the longitudinal slot 4. Thus, the pickup 5 can be moved back and forth in the data zone between the inner ring and the outer ring of the optical disk 3 to search a target data position.

Usually, the disk drive 1 is placed in a horizontal state represented by the H direction, and the gravity force of the pickup 5 is perpendicular to the moving direction of the pickup 5, so the driving force is free from being influenced by the gravity force of the pickup 5. In order to match with the spatial limitation or the requirement of the portable electronic product, the disk drive 1 is sometimes placed in a vertical state, as shown in the vertical direction indicated by the V+ direction of FIG. 1. When the disk drive 1 operates in the V+ vertical direction, the longitudinal slot 4 tilts upwards from the spindle motor 2, and the gravity force of the pickup 5 increases or decreases the loading of the driving force, deteriorates the control precision of the driving force, and lengthens the time for the pickup 5 to reach the target data position. Similarly, the longitudinal slot 4 tilts downwards from the spindle motor 2 when the disk drive is placed in another vertical direction indicated by the V− direction, the condition of deteriorating the control precision of the driving force also occurs.

In order to solve the above-mentioned problems, the prior art judges the horizontal or vertical operation type of the disk drive, according to the moving speed difference of the pickup or the variation of the focus error signal, to compensate for the control of the driving force. However, the prior art does not consider the wear of the transmission parts of the pickup, the environment migration or the expansion and contraction due to the temperature variation. Thus, the variation of transmission resistance or signal error is caused, and the horizontal or vertical operation type of the disk drive tends to be misjudged. The prior art does not have the mechanism of detecting the misjudgment and immediately correcting the operation type, so the overall operation efficiency of the disk drive deteriorates once the misjudgment is made. Thus, there are some problems to be solved in the method of judging the operation type of the disk drive in the prior art.

### SUMMARY OF THE INVENTION

It is therefore an object of the invention to provide a method for automatically correcting an operation type of a disk drive by detecting a number of times of abnormal track seeking to automatically correct the operation type and avoid the misjudgment.

Another object of the invention is to provide a method of automatically correcting an operation type of a disk drive according to the operation type of track seeking and the track seeking direction when the abnormal track seeking occurs.

Still another object of the invention is to provide a method of automatically correcting an operation type of a disk drive by immediately switching the operation type according to the judgment of the operation type to timely enhance the efficiency of the disk drive.

Yet still another object of the invention is to provide a method of automatically correcting an operation type of a disk drive, wherein the method gets an averaged number of times of track seeking of one track seeking command by way of averaging under a predetermined number of times of the track seeking command so as to enhance the reliability of judging the disk drive and switching the operation type.

Yet still another object of the invention is to provide a method of automatically correcting an operation type of a disk drive, wherein the method keeps the original operation type setting by limiting a maximum number of times of switching the operation type of the disk drive so as to avoid the frequent switching caused by the abnormal state and thus to stabilize the operation of the disk drive.

The invention achieves the above-identified objects by providing a method of automatically correcting an operation type of a disk drive. The method includes the steps of:
(1) executing a track seeking command;
(2) recording a number of times of track seeking required to finish the track seeking command;
(3) judging whether the number of times of track seeking are greater than a standard;
(4) judging the track seeking command as a predetermined track seeking direction when the number of times of track seeking are greater than the standard;
(5) identifying an operation type setting of the disk drive; and
(6) switching the operation type of the disk drive.

The invention sets the number of times of normal track seeking of the disk drive as a standard, detects whether the number of times of track seeking of the track seeking command is greater than the standard when executing the track seeking command, judges the occurrence of the abnormal track seeking phenomenon, and judges the correct operation type according to the operation type setting of the disk drive and the track seeking direction to automatically correct and switch the misjudged operation type setting into the correct operation type to timely revise the misjudged operation type setting. In addition, the invention restores the original operation type setting after the operation type exceeds the maximum number of times so as to prevent the frequent switching caused by the abnormal state.

The invention may also set multiple times of the track seeking command with the same direction by averaging to obtain the averaged number of times of the track seeking as a reference for the automatic switching and correcting of the operation type. The invention includes the steps of:
(1) executing a track seeking command;
(2) judging track seeking directions of the track seeking command as having a predetermined direction;
(3) adding a number of times of track seeking for finishing the track seeking command to a track seeking time record M, and accumulating a time record of the track seeking command;
(4) comparing the time record of the track seeking command with a default number;
(5) averaging the number of times of track seeking when the time record of the track seeking command equals the default number;
(6) excuting the steps of the method of automatically correcting the operation type; and
(7) zeroing the time record of the track seeking command and the track seeking time record.

Thus, it is possible to prevent the mixing of the abnormal track seeking, which causes the frequent switching of the operation type, when the disk drive has the abnormal operation or vibration, and thus to keep the operation of the disk drive stable.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a top view showing a conventional disk drive.

FIG. 2A is a schematic illustration showing a free body diagram when a pickup of a disk drive is forced in a V+ vertical operation type.

FIG. 2B is a schematic illustration showing a free body diagram when a pickup of a disk drive is forced in a V− vertical operation type.

FIG. 3 is a flow chart showing a method of automatically correcting an operation type of a disk drive according to a first embodiment of the invention.

FIG. 4 is a flow chart showing a method of automatically correcting an operation type of a disk drive according to a second embodiment of the invention.

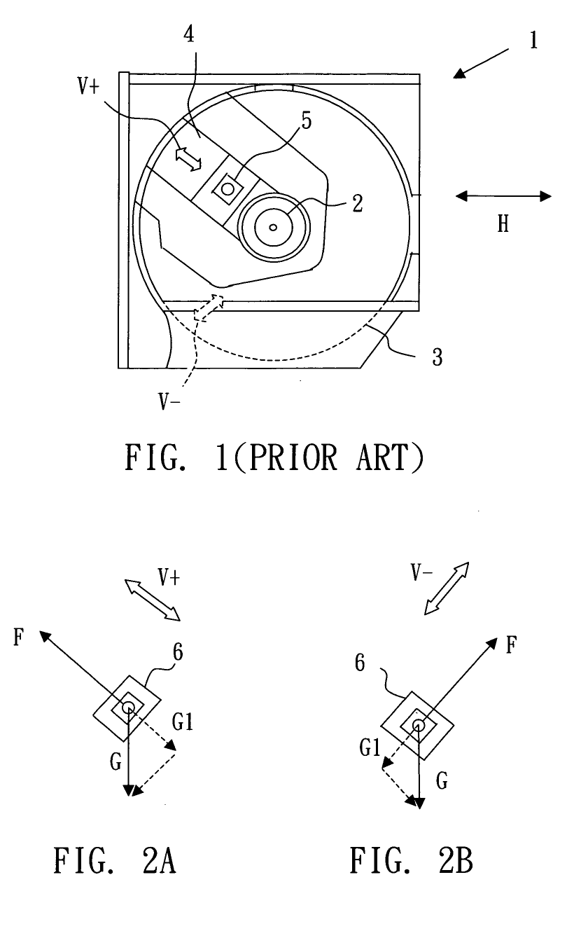

### DETAILED DESCRIPTION OF THE INVENTION

The invention will be described with reference to the accompanying drawings.

The method of the invention for automatically correcting the operation type of the disk drive mainly utilizes the driving force of the misjudged operation type of the disk drive to drive the pickup to execute track seeking from an inner ring to an outer ring of the optical disk, or from the outer ring to the inner ring of the optical disk. Some track seeking direction tends to increase the loading of the driving force due to the gravity force of the pickup. So, the driving force of the misjudged operation type is not large enough, which abnormally increases the number of times of track seeking for the disk drive to reach the required target data position of the track seeking command when the disk drive is executing the track seeking command.

As shown in FIG. 2A, for example, if the disk drive actually has the vertical V+ operation type but is misjudged as the horizontal H operation type, the disk drive pushes the pickup 6 to seek the track slantingly upwards with the driving force F set according to the horizontal H operation type. That is, the pickup is moved from the inner ring of the optical disk to the outer ring of the optical disk. Because the pickup 6 itself has the gravity force G, which forms a component G1 in the direction of the driving force F. The direction of the component G1 is opposite to the direction of the driving force F to partially offset the driving force F such that the driving force for pushing the pickup 6 is not large enough. The insufficient force F hinders the pickup 6 from being pushed to the track seeking target required by the track seeking command. Thus, several times of tracking on must be repeated to identify the address, calculate the distance to the track seeking target and seek the track to reach the track seeking target. Thus, the number of times of track seeking required to finish the track seeking command is increased significantly as compared to the number of times of normal track seeking.

In the same misjudgment, however, the disk drive utilizes the driving force F set according to the horizontal H operation type to push the pickup 6 to seek the track slantingly downward. That is, the pickup is moved from the outer ring to the inner ring of the disk. The component G1 of the gravity force G of the pickup 6 and the driving force F have the same direction. So, the component G1 compensates for the insufficient driving force F to push the pickup 6 such that the pickup 6 can reach the track seeking target required by the track seeking command, and no abnormal track seeking will be caused. Therefore, the disk drive may be judged as actually having the vertical V+ operation type when the disk drive is misjudged as having the horizontal H operation type according to the abnormal track seeking, which is generated by driving the pickup and occurs when the pickup seeks the track from the inner ring to the outer ring of the optical disk.

Similarly, as shown in FIG. 2B, when the disk drive actually having the vertical V− operation type is misjudged as having the horizontal H operation type, the pickup 6 is pushed from the inner ring to the outer ring of the optical disk to execute the track seeking. The component G1 of the gravity force G of the pickup 6 and the driving force F have the same direction to compensate for the insufficient driving force F, and no abnormal track seeking occurs. However, when the pickup 6 is pushed to seek the track from the outer ring to the inner ring of the optical disk, the component G1 of the gravity force G of the pickup 6 and the driving force F have opposite directions. Thus, the force for pushing the pickup 6 is insufficient, and the abnormal track seeking occurs and the disk drive can be judged as actually having the vertical V− operation type.

In addition, when the disk drive actually having the horizontal H operation type is misjudged as having the vertical V+ operation type, the disk drive utilizes the driving force F set according to the vertical V+ operation type to push the pickup to move, and the magnitude of the driving force F of the vertical V+ operation type is adjusted according to the influencing factor of the gravity force G of the pickup with respect to the slantingly upward and slantingly downward movements. As shown in FIG. 2A, when the pickup is pushed up from the inner ring of the optical disk to the outer ring of the optical disk to seek the track slantingly upward, the used driving force F will be larger in order to overcome the component G1 of the gravity force G. Thus, when the disk drive actually has the horizontal H operation type without the influence of the gravity force G, the larger driving force F will not form the resisting force and the track seeking is normal. However, when the pickup 6 is seeking the track slantingly downward from the outer ring to the inner ring of the optical disk, the used driving force F will be smaller because of the component G1 of the gravity force G. When the disk drive actually has the horizontal H operation type without the influence of the gravity force G, the insufficient force tends to cause the abnormal track seeking, and the disk drive can be judged as actually having the horizontal H operation type.

Similarly, referring to FIG. 2B, when the disk drive actually having the horizontal H operation type is misjudged as having the vertical V− operation type, the abnormal track seeking occurs when the pickup 6 is pushed from the inner ring to the outer ring of the optical disk slantingly downward to seek the track, and the disk drive may be judged as actually having the horizontal H operation type. Thus, it is possible to know that the disk drive have abnormal track seeking as long as the number of times of normal track seeking is set as a standard followed by detecting whether the number of times of track seeking is greater than the standard. In addition, it is possible to judge whether the operation type setting of the disk drive is incorrect according to the operation type of the disk drive setting and the track seeking direction, and the operation type can be timely corrected and switched into the correct operation type.

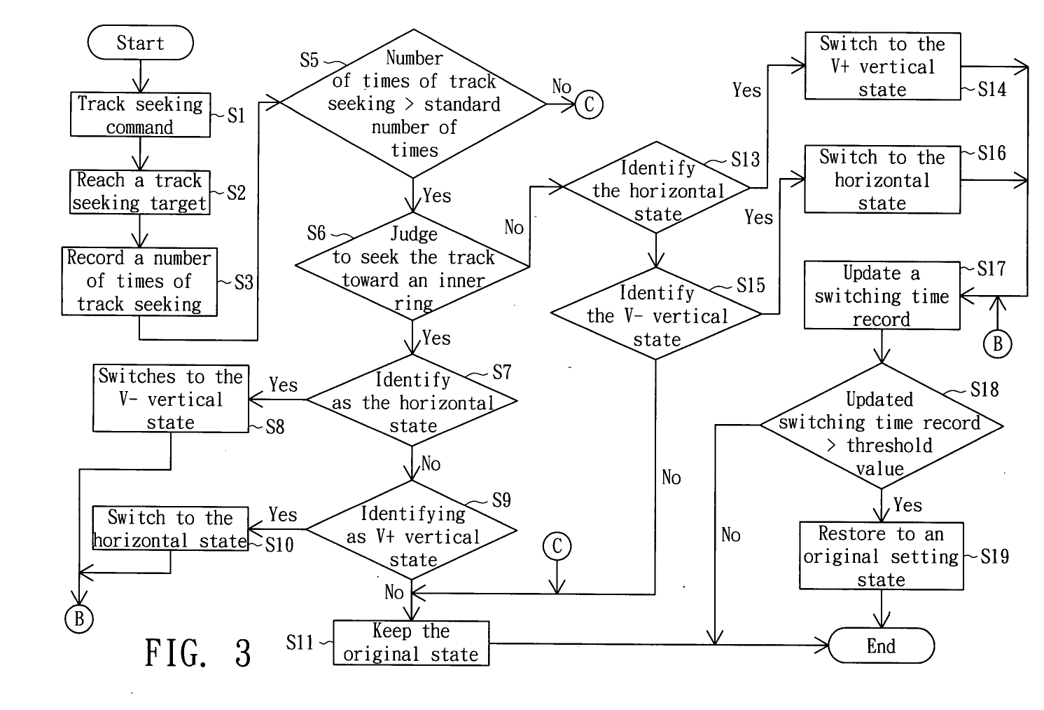

The method of automatically correcting the operation type of the disk drive of the invention will be described with reference to FIG. 3.

Step S1 starts to execute the method of automatically correcting the operation type of the disk drive according to the invention.

In step S2, the disk drive receives a track seeking command to request the pickup to execute the track seeking toward a target data address.

In step S3, several times of tracking on are repeated to identify the address, the distance from the pickup to the track seeking target is calculated and the track seeking is executed again to make the pickup reach the track seeking target.

Step S4 records and updates the number of times of track seeking of finishing the track seeking command of step 3 to make the pickup reach the track seeking target to form a track seeking time record.

Step S5 judges whether the track seeking time record is greater than the default standard to cause the abnormal track seeking condition. If not, step S11 is performed; and if yes, the next step is performed.

Step S6 judges the track seeking direction for the track seeking command to request the pickup to execute the track seeking to the target data address in step S2. That is, step S6 judges whether the moving direction of the pickup from the current position to the target data address is the seeking direction toward an inner ring of the optical disk. If not, step S13 is performed; and if yes, the next is performed.

Step S7 identifies whether the operation type of the disk drive setting pertains to the horizontal operation type. If yes, the next step is performed; and if not, step S9 is performed.

Step S8 switches the horizontal operation type setting of the disk drive into the vertical V− operation type setting and then goes to step S17 to update the switching time record.

Step S9 identifies whether the operation type setting of the disk drive pertains to the vertical V+ operation type. If yes, the next step is performed; and if not, step S11 is performed.

Step S10 switches the vertical V+ operation type setting of the disk drive into the horizontal operation type setting, and then goes to step S17 to update the switching time record.

Step S11 keeps the original operation type setting without switching the operation type, and goes to the next step.

Step S12 ends the procedure of switching the operation type of the disk drive.

Step S13 is performed when step S6 judges that the pickup does not perform the track seeking in a direction toward the inner ring of the optical disk (i.e., toward the outer ring of the optical disk). Step S13 identifies whether the operation type setting of the disk drive pertains to the horizontal operation type. If yes, the next step is executed; and if not, step S15 is executed.

Step S14 switches the horizontal operation type setting of the disk drive into the vertical V+ operation type setting and then enters step S17 to update the switching time record.

Step S15 identifies whether the operation type setting of the disk drive pertains to the vertical V− operation type. If yes, the next step is executed; and if not, step S11 is executed.

Step S16 switches the vertical V− operation type setting of the disk drive into the horizontal operation type setting, and then goes to the next step.

Step S17 updates the switching time record by adding one to the switching time record to obtain a new switching time record, and then goes to the next step.

Step S18 executes the comparison to determine whether the switching time record is greater than a pre-set threshold value. If not, step S12 is executed to end the procedure of switching the operation type of the disk drive; and if yes, the next step is executed.

In step S19, when the switching time record is greater than the threshold value, the operation type is restored to the original setting and goes to step S12 to end the procedure of switching the operation type of the disk drive.

According to the steps of automatically switching and correcting the operation type of the disk drive, the invention only has to set the number of times of normal track seeking as a standard, and detect whether the number of times of track seeking of the track seeking command is greater than the standard when each track seeking command is executed. Thus, then occurrence of the abnormal track seeking phenomenon is judged to identify whether the operation type setting is normal. In addition, the correct operation type is judged according to the operation type setting of the disk drive and the track seeking direction, and the misjudged operation type setting is automatically corrected and switched into the correct operation type to match with the change of the operation environment of the disk drive momentarily when someone enters or leaves the conditioning room, for example. Thus, the misjudged operation type setting can be timely revised, and the efficiency of the disk drive is enhanced. In addition, the invention restricts the maximum number of times of switching the operation type of the disk drive in step S18 such that the original operation type setting is restored after the number of switching times of the operation type exceeds the maximum number of times. Thus, it is possible to avoid the frequent switching caused by the abnormal state when the poor optical disk is used, for example, to stabilize the operation of the disk drive.

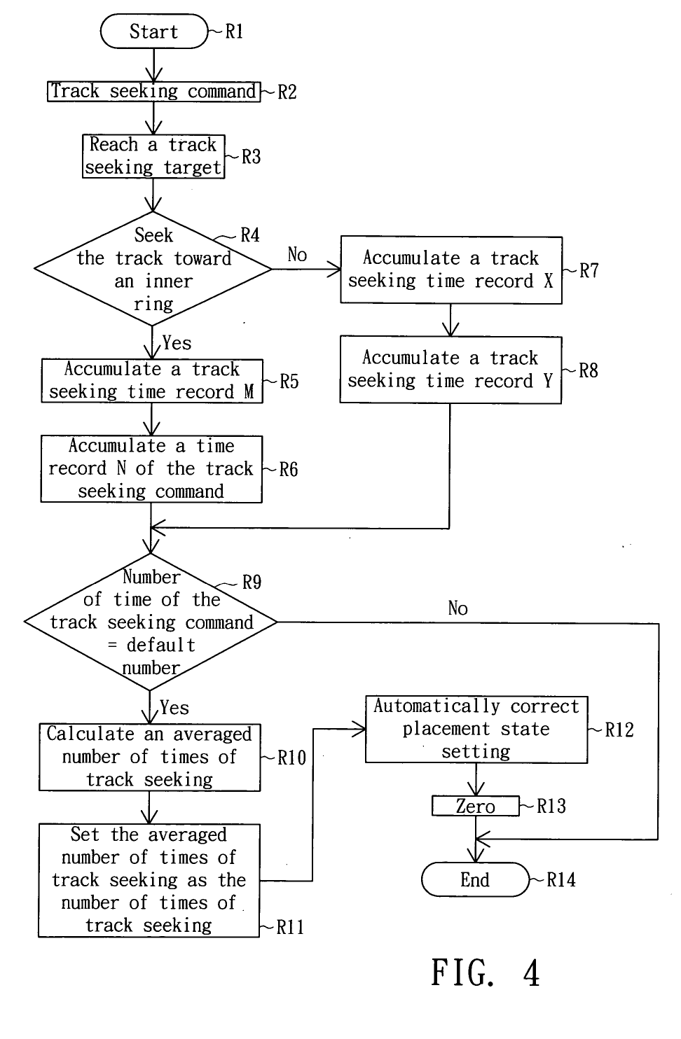

FIG. 4 is a flow chart showing a method of automatically correcting an operation type of a disk drive according to a second embodiment of the invention. As shown in FIG. 4, the method according to this embodiment is almost the same as the first embodiment, in which the operation type is automatically switched and corrected according to each track seeking command, except that the second embodiment averages multiple times of track seeking commands with the same track seeking direction to obtain the averaged number of times of track seeking as the reference for automatically correcting and switching the operation type. The method of automatically correcting the operation type according to the second embodiment of the invention will be described in the following.

Step R1 starts the method of automatically correcting the operation type of the disk drive of the invention.

In step R2, the disk drive receives a track seeking command to request the pickup to execute the track seeking to a target data address.

Step R3 repeats multiple times of tracking on, identifies the address, calculates the distance from the pickup to the track seeking target and then executes the track seeking to make the pickup reach the track seeking target.

Step R4 judges whether the track seeking directions (i.e., from the current position of the pickup to the target data address) of the track seeking command for requesting the pickup to execute the track seeking to the target data address in step R2 pertain to the same direction (e.g., toward the inner ring of the optical disk). If not, step R8 is performed. If yes, the next step is performed.

In step R5, when the track seeking direction is toward an inner ring of the optical disk, the number of times of track seeking for finishing the track seeking command is accumulated into the track seeking time record M.

Step R6 accumulates the number of times of track seeking for finishing the track seeking command into a time record N of the track seeking command, and then goes to step R9.

In step R7, when the track seeking directions are not the same direction (i.e., toward the outer ring of the optical disk), the number of times of track seeking for finishing the track seeking command is accumulated into the track seeking time record X.

Step R8 accumulates the number of times of track seeking for finishing the track seeking command into a time record Y of the track seeking command.

Step R9 performs the comparison to determine whether the time record N or Y of the track seeking command is equal to the default number. If not, step R14 is executed. If yes, the next step is executed.

In step R10, when the time record N or Y of the track seeking command is equal to the default number, the track seeking time record M or X is divided by the time record N or Y of the track seeking command to calculate the averaged number of times of track seeking for finishing the track seeking command.

Step R11 sets the averaged number of times of track seeking obtained in step R10 as the number of times of track seeking of automatically correcting the operation type.

Step R12 automatically corrects the operation type. This step is similar to the steps S5 to S19 exclusive of the ending step S12 in the first embodiments.

Step R13 zeros the time record N or Y of the track seeking command, and the track seeking time record M or X.

Step R14 ends the procedure of switching the operation type of the disk drive.

According to the steps of automatically switching and correcting the operation type of the disk drive, this embodiment can obtain the averaged number of times of track seeking for finishing one track seeking command within the predetermined number of times of track seeking. Thus, it is possible to prevent the abnormal track seeking condition caused by the abnormal operation or vibration of the disk drive, which sometimes occurs, from influencing the track seeking to cause the misjudgment or the frequent switching of the operation type. Thus, the operation state of the disk drive can be kept stable, and the reliability of judging and switching the operation type of the disk drive can be enhanced.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of automatically correcting an operation type of a disk drive, the method comprising the steps of;
(1) executing a track seeking command;
(2) recording a number of times of track seeking required to finish the track seeking command;
(3) judging whether the number of times of track seeking is greater than a standard;
(4) judging the track seeking command as a predetermined track seeking direction when the number of times of track seeking is greater than the standard;
(5) identifying an operation type setting of the disk drive; and
(6) switching the operation type of the disk drive.

2. The method according to claim 1, wherein the step (4) keeps an original operation type setting and ends the step of switching the operation type of the disk drive when a recorded number of times of track seeking is not greater than the standard.

3. The method according to claim 1, wherein the standard in the step (4) is the number of times of normal track seeking of the disk drive.

4. The method according to claim 1, wherein the disk drive further rotates an optical disk, and the predetermined track seeking direction in the step (4) is a track seeking direction toward an inner ring of the optical disk.

5. The method according to claim 4, wherein when the step (5) judges the operation type of the disk drive as a horizontal setting, the step (6) switches the disk drive into a vertical V− operation type setting.

6. The method according to claim 4, wherein when the step (5) judges the operation type of the disk drive as a vertical V+ operation type setting, the step (6) switches the disk drive into a horizontal operation type setting.

7. The method according to claim 4, wherein when the step (5) judges that the operation type of the disk drive is neither a horizontal nor vertical V+ operation type setting, the step (6) keeps the disk drive as an original operation type setting and ends the step of switching the operation type of the disk drive.

8. The method according to claim 1, wherein the disk drive further rotates an optical disk, and the predetermined track seeking direction in the step (4) is a track seeking direction toward an outer ring of the optical disk.

9. The method according to claim 8, wherein when the step (5) judges the operation type of the disk drive as the horizontal setting, the step (6) switches the disk drive into the vertical V+ operation type setting.

10. The method according to claim 8, wherein when the step (5) judges the operation type of the disk drive as the vertical V− operation type setting, the step (6) switches the disk drive into the horizontal operation type setting.

11. The method according to claim 8, wherein when the step (5) judges that the operation type of the disk drive is neither an horizontal nor vertical V− operation type setting, the step (6) keeps the disk drive as the original operation type setting and ends the step of switching the operation type of the disk drive.

12. The method according to claim 1, further comprising, after the step (6), a step (7) of updating a switching time record by adding one to the switching time record as a new switching time record.

13. The method according to claim 12, further comprising, after the step (7), a step (8) of comparing the switching time record with a threshold value, and restoring the operation type to an original setting and ending the step of switching the operation type of the disk drive when the switching time record is greater than the threshold value.

14. The method according to claim 13, wherein when the switching time record is not greater than the threshold value in the step (8), the switching of the operation type of the disk drive ends.

15. A method for automatically correcting an operation type of a disk drive, the method comprising:
(1) executing a track seeking command;
(2) judging track seeking directions of the track seeking command as having a predetermined direction;
(3) adding a number of times of track seeking for finishing the track seeking command to a track seeking time record M, and accumulating a time record of the track seeking command N;
(4) judging whether the time record of the track seeking command N is equal to a default number, If not, performing step (6), and If yes, performing the next step;
(5) averaging the number of times of track seeking;
(6) automatically correcting the operation type; and
(7) zeroing the time record of the track seeking command and the track seeking time record.

16. The method according to claim 15, wherein the disk drive further rotates an optical disk and the track seeking directions in the step (2) are the same predetermined direction, which is a track seeking direction toward an inner ring of the optical disk.

17. The method according to claim 16, wherein when the time record of the track seeking command is smaller than a default number in the step (4), the step of switching the operation type of the disk drive ends.

18. The method according to claim 16, wherein the step (5) divides the track seeking time record by the time record of the track seeking command to calculate an averaged number of times of track seeking.

19. The method according to claim 16, wherein the step (6) automatically corrects the operation type according to the averaged number of times of track seeking.
